(19) United States
(12) Patent Application Publication
(10) Pub. No.: US 2013/0309650 A1
(43) Pub. Date: Nov. 21, 2013

(54) BINDER OF DRY ERASE PAGES

(71) Applicant: Peter William Carney, Woodland, GA (US)

(72) Inventor: Peter William Carney, Woodland, GA (US)

(21) Appl. No.: 13/897,335

(22) Filed: May 17, 2013

Related U.S. Application Data
(60) Provisional application No. 61/649,298, filed on May 20, 2012.

(51) Int. Cl. B43L 1/00

(52) U.S. Cl. CPC B43L 1/00
USPC 434/414

(57) ABSTRACT

A note taking binder gives the user the ability to take notes while dealing neither with the cumbersome tablet PC interface, nor with the fear of running out of battery life. The notes taken with the note taking binder can be photographed more easily than standard pencil and paper notes due to the thickness of the dry erase pages that make up the binder. The pages can also be erased more easily so that the pages can be reused numerous times. This gives the user practically all the benefits of taking and storing notes digitally on his or her digital device of choice. The binder is better than taking notes on a digital device because the notes can be taken and remain visible for extended periods of time without fear of battery depletion. Moreover, the binder allows the user to erase individual characters or diagrams as they are writing.

### CROSS-REFERENCE TO RELATED APPLICATION

This application claims the benefit of priority of U.S. provisional application No. 61/649,298, filed May 20, 2012, the contents of which are herein incorporated by reference.

### BACKGROUND OF THE INVENTION

The present invention relates to notebooks and, more particularly, to a binder of dry erase pages for taking notes to be photographed, optically scanned, or the like. The invention provides a means to create and record, via a photographic or digital device, one or more pages of hand written notes and diagrams.

Taking notes via the traditional paper method produces documents that must be stored and are not easily copied and/or shared. Furthermore, taking notes via a tablet PC and a stylus is often cumbersome and can only be done while the tablet has sufficient battery life. Moreover, people are used to being able to, and often need to, view their notes soon after they record them. For instance, one may have to reference notes just taken on the previous page in order to continue with their current notes on the new page.

Currently, a device on the market allows a user to write on it and, when it is full of notes, the user pushes a button and the page is saved as a PDF file and erased for more notes to be written. This, however, does not allow a user to erase individual characters or diagrams without erasing the entire page, write more than one page work before having to erase, or view the notes until the device is attached to a PC-like device to upload the PDF's to view what was written.

Clearly, there is a need for an improved note taking device that is simple, easy to use and does not depend on battery or other power sources.

### SUMMARY OF THE INVENTION

In one aspect of the present invention, a note taking binder comprises plurality of pages; a binding holding the plurality of pages together; a dry-erase writing surface on at least one side of the plurality of pages; and a spacer disposed to prevent the dry-erase writing surface from rubbing against another flat surface when adjacent ones of the plurality of pages are disposed adjacent to each other.

In another aspect of the present invention, a note taking binder comprises a plurality of pages, including a front and back cover and a plurality of central pages disposed therebetween; a binding passing through holes formed along an edge of each of the plurality of pages, the binding holding the plurality of pages together; a dry-erase writing surface on at least one side of the plurality of pages; and a spacer disposed to prevent the dry-erase writing surface from rubbing against another flat surface when adjacent ones of the plurality of pages are disposed adjacent to each other, wherein the spacers are offset such that spacers on adjacent pages do not contact each other when the note taking binder is closed.

These and other features, aspects and advantages of the present invention will become better understood with reference to the following drawings, description and claims.

### BRIEF DESCRIPTION OF THE DRAWINGS

FIG. 1 is a perspective view of a dry erase binder according to an exemplary embodiment of the present invention;

FIG. 2 is a perspective view of the dry erase binder of FIG. 1, opened to a page of text, illustrating obtaining a digital image of the notes hand-written on one of the pages thereof;

FIG. 3 is a side view of the dry erase binder of FIG. 1; and

FIG. 4 is a cross-sectional view taken along line 4-4 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a note taking binder that gives the user the ability to take notes with neither dealing with the cumbersome tablet PC interface, nor dealing with the fear of running out of battery life. The notes taken with the note taking binder can be photographed more easily than standard pencil and paper notes due to the thickness of the dry erase pages that make up the note taking binder. The pages can also be erased more easily so that the pages can be reused numerous times. This gives the user practically all the benefits of taking and storing notes digitally on his or her digital device of choice. The binder of the present invention is better than taking notes on a digital device because the notes can be taken and remain visible for extended periods of time without fear of battery depletion. Moreover, the binder of the present invention allows the user to erase individual characters or diagrams as they are writing.

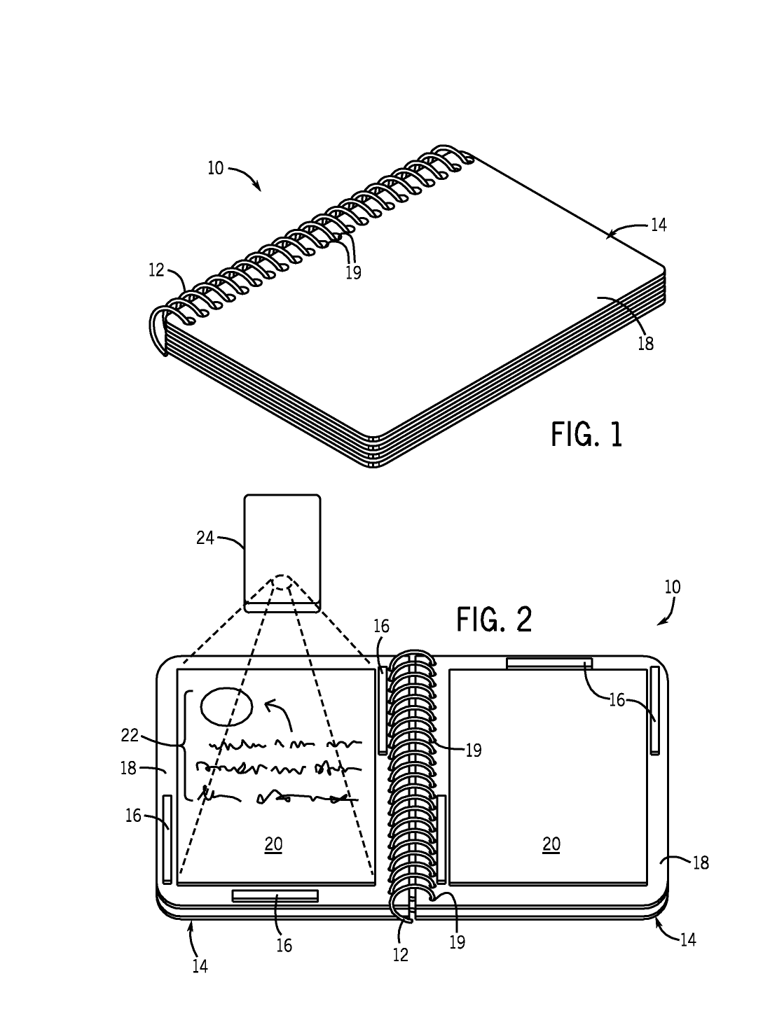

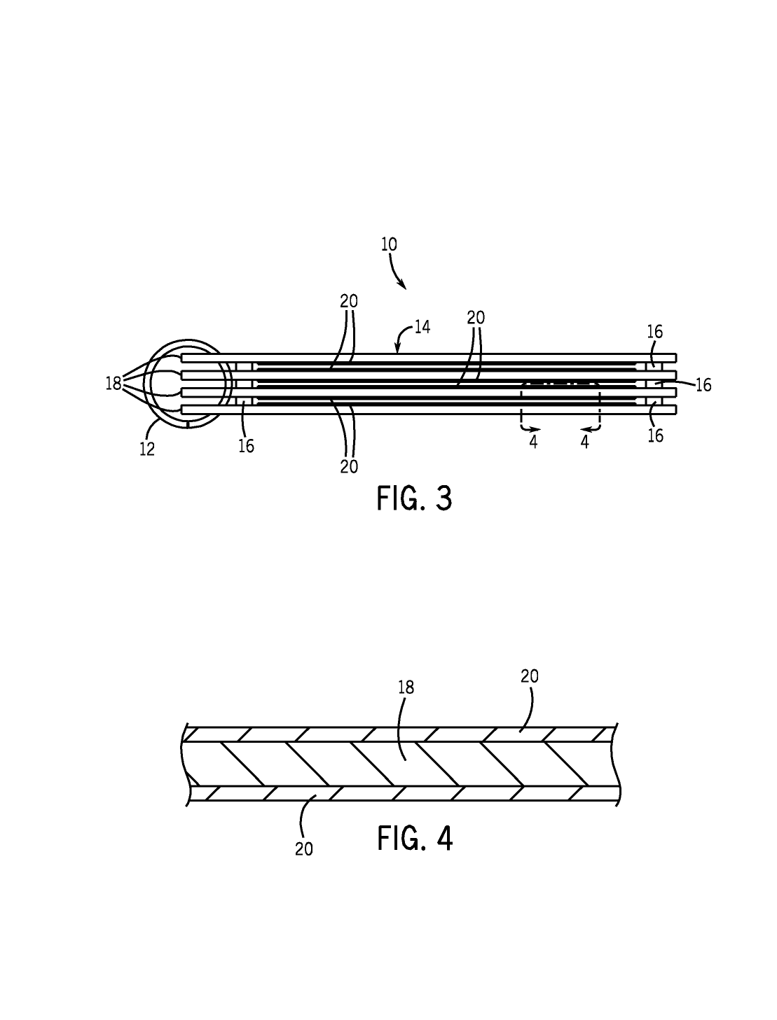

Referring now to FIGS. 1 through 4, a binder 10 may include a plurality of pages 14, including front and back covers, with one or more pages disposed between the front and back covers. Each of the pages 14 can be joined together by a binding 12, such as a wire binding, passed through a series of holes 19 cut along one edge of these pages 14. A dry-erase surface 20 may be disposed on the inside of each of the front and back covers as well as on each side of the pages 14. The pages could be metallic and conductive to magnets, similar to many standard dry erase boards.

Typically, the pages 14 are made of a substrate 18 that results in stiff pages and may be made of various materials, such as plastic. The dry-erase surface 20 may be attached to the substrate 18 (including the front and back covers) with an adhesive, for example. In some embodiments, the dry-erase surface 20 may be made integrally with the substrate 18 (and the front and back covers) and the time of manufacture.

The pages 14 having the dry-erase board may be configured such that a spacer 16 is disposed between the pages 14, about at least a portion of the periphery of the pages 14, such that the dry-erase surfaces 20 do not rub against each other when the binder 10 is closed. The spacers 16 may be foam rubber or plastic pads or strips that may be put on each of the pages 14, furthermore the spacers 14 may be integral to the stiff substrates 18. In some embodiments, as shown in the Figures, the spacers 16 may be offset so that a spacer 16 on one page 14 abuts the adjacent page 14, and the spacer 16 on that adjacent page 14 abuts the first page 14 (in other words, the spacers 16 do not abut against each other, but only abut against an adjacent page).

The wire binding 12 holds the pages 14 together in an orderly fashion, providing easy access for the user to all of the pages. The dry-erase surfaces 20 located on each stiff substrate 18 allow the user to write on the surface 20 with a dry-erase marker. The multiple pages 14 allow the user to write numerous characters and diagrams 22 for whatever purpose desired. When the user is done, or has run out of empty dry-erase space on all of the sheets, the user can then photograph each sheet to be stored on the user's digital device 24. The written characters and diagrams can them be easily erased via a standard dry-erase eraser in order to repeat the process. The user can now access, edit, copy or share the user's notes via the digital device 24 which now stores photographs of the written notes.

One possible variation could include the following. Instead of using a standard dry erase surface on all of the pages, one could use transparency paper or simply a laminated piece of paper. As long as it is dry erase compatible than it would work with the design. One reason for using a laminated piece of paper, for example, would be to give the user grid lines, guidelines, or any other design would assist in the note taking experience.

Another possible variation could include to following. The binder 10 could possibly be used or incorporated into a case for a tablet PC, having some sort of attachment system to the tablet PC itself. Additionally, a logo or symbol could be applied to the pages in order to better interact with the digital device that is being used to photograph or otherwise capture the notes.

It should be understood, of course, that the foregoing relates to exemplary embodiments of the invention and that modifications may be made without departing from the spirit and scope of the invention as set forth in the following claims.

What is claimed is:

1. A note taking binder comprising:
a plurality of pages;
a binding holding the plurality of pages together;
a dry-erase writing surface on at least one side of the plurality of pages; and
a spacer disposed to prevent the dry-erase writing surface from rubbing against another flat surface when adjacent ones of the plurality of pages are disposed adjacent to each other.

2. The note taking binder of claim 1, wherein the plurality of pages includes a front cover and a back cover and at least one center page disposed between the front cover and the back cover.

3. The note taking binder of claim 1, wherein the binder is a wire binder fitting through holes disposed along one side of the plurality of pages.

4. The note taking binder of claim 1, wherein the spacer are formed of a form rubber or plastic pad or strip.

5. The note taking binder of claim 1, wherein the spacers are integrated with a substrate for each of the plurality of pages.

6. The note taking binder of claim 1, wherein the spacers are offset such that spacers on adjacent pages do not contact each other when the note taking binder is closed.

7. A note taking binder comprising:
a plurality of pages, including a front and back cover and a plurality of central pages disposed therebetween;
a binding passing through holes formed along an edge of each of the plurality of pages, the binding holding the plurality of pages together;
a dry-erase writing surface on at least one side of the plurality of pages; and
a spacer disposed to prevent the dry-erase writing surface from rubbing against another flat surface when adjacent ones of the plurality of pages are disposed adjacent to each other, wherein
the spacers are offset such that spacers on adjacent pages do not contact each other when the note taking binder is closed.

8. The note taking binder of claim 7, wherein the spacer are formed of a form rubber or plastic pad or strip.

9. The note taking binder of claim 7, wherein the spacers are integrated with a substrate for each of the plurality of pages.

10. The note taking binder of claim 7, wherein the binder is a wire binder.
